(19) United States
(12) Patent Application Publication
(10) Pub. No.: US 2025/0260551 A1
(43) Pub. Date: Aug. 14, 2025

(54) DATA DIODE AND TRANSMISSION CONTROL METHOD

(71) Applicant: Azbil Corporation, Tokyo (JP)

(72) Inventors: ATSUSHI KATSUMATA, Tokyo (JP); ITSUKI TANABE, Tokyo (JP); FUMIAKI YAMASAKI, Tokyo (JP); MAMORU KAGOURA, Tokyo (JP)

(73) Assignee: Azbil Corporation, Tokyo (JP)

(21) Appl. No.: 18/967,651

(22) Filed: Dec. 4, 2024

(30) Foreign Application Priority Data
Feb. 13, 2024 (JP) 2024-019080

(51) Int. Cl. H04L 5/14; H04L 25/05

(52) U.S. Cl. CPC H04L 5/1461; H04L 25/05

(57) ABSTRACT

A receiving device includes a determination part that determines the necessity of suppressing data transmission from a transmitting device via a unidirectional communication part, and a transmission suppression part that outputs a transmission suppression signal to the unidirectional communication part when the determination part determines that suppression of data transmission is necessary. The unidirectional communication part, when receiving the transmission suppression signal from the transmission suppression part, stops transmitting data transmitted by the transmitting device to the receiving device and the transmitting device. The transmitting device includes a comparison part that compares transmitted data with data from the unidirectional communication part, and stops data transmission when the comparison part determines that data do not match.

### CROSS-REFERENCE TO RELATED APPLICATION

This application claims the priority benefit of Japan Application No. 2024-019080, filed on Feb. 13, 2024. The entirety of the above-described patent application is hereby incorporated by reference herein and made a part of the present specification.

### BACKGROUND

### Technical Field

The disclosure relates to a data diode that performs unidirectional communication, and a transmission control method using a data diode.

### Related Art

An operational technology (OT) network (control network) used in automation in a factory or the like is used for controlling various devices and is very important. In the case of this control network being maliciously hijacked, the control of the devices may become abnormal, leading to accidents that would not occur under normal circumstances.

Such an important control network generally maintains its security by not connecting to other networks.

On the other hand, there is a desire to use information generated on the control network externally. In such cases, a data diode is effective. This data diode enables communication in only one direction and is effective as a method for physically enhancing network security (see, for example, Japanese Patent Laid-Open No. 2015-133558).

In this manner, the data diode physically enables communication in only one direction. Hence, even if a malicious person attempts to hijack the data diode, there is no network for them to enter. To guarantee the above, no information transmission path in the reverse direction can be provided in the data diode in any way.

In this manner, since the data diode enables communication in only one direction, it is generally not possible for a transmitting side to obtain information from a receiving side. Hence, it is not possible to temporarily stop the transmission from the transmitting side according to the circumstances of the receiving side.

Here, a case is considered where data reception becomes temporarily difficult due to a state in which a buffer on the receiving side is full or the like.

In such cases, for example, in general communication, the receiving side communicates this state to the transmitting side and requests the transmitting side to temporarily stop transmission, thereby realizing high-quality communication.

However, the operation as described above cannot be implemented in the data diode. That is, in the data diode, due to unidirectional communication, how the data received accumulates on the receiving side cannot be grasped by the transmitting side.

Hence, generally, in the case of the data diode, a network is designed with sufficient margin to prevent the state as described above from occurring. In the event that the state as described above does occur, in the data diode, data may be lost, and because it is not possible to communicate this loss to the transmitting side, the communication may become incomplete.

How the data accumulates on the receiving side is determined by a data rate transmitted from the transmitting side and a data rate transmitted via an information technology (IT) network from the receiving side.

If the data rate on the receiving side is slow, for example, in the case where the IT network is congested, data from the transmitting side may accumulate and the buffer may not be able to store all the data, resulting in overflow and potential data loss.

### SUMMARY

A data diode according to the disclosure includes: a transmitting device, transmitting data from a control network; a receiving device, transmitting input data to a business network; and a unidirectional communication part, transmitting data transmitted by the transmitting device to the receiving device and the transmitting device. The receiving device includes: a determination part, determining the necessity of suppressing data transmission from the transmitting device via the unidirectional communication part; and a transmission suppression part, in response to the determination part determining that suppression of data transmission is necessary, outputting a transmission suppression signal to the unidirectional communication part. The unidirectional communication part, in response to receiving the transmission suppression signal from the transmission suppression part, stops transmitting data transmitted by the transmitting device to the receiving device and the transmitting device. The transmitting device includes a comparison part that compares transmitted data with data from the unidirectional communication part, and the transmitting device stops data transmission in response to the comparison part determining that data do not match.

### BRIEF DESCRIPTION OF THE DRAWINGS

FIG. 1 illustrates a configuration example of a data diode according to Embodiment 1.

FIG. 2A to FIG. 2C illustrate configuration examples (in the case where the data diode uses electrical signals) of a unidirectional communication part in Embodiment 1.

FIG. 3A and FIG. 3B illustrate configuration examples (in the case where the data diode uses electrical signals) of the unidirectional communication part in Embodiment 1.

FIG. 4A and FIG. 4B illustrate configuration examples (in the case where the data diode uses optical signals) of the unidirectional communication part in Embodiment 1.

FIG. 5 is a flowchart illustrating an example of a transmission control operation in the data diode according to Embodiment 1.

FIG. 6 illustrates a configuration example of a data diode according to Embodiment 2.

### DESCRIPTION OF THE EMBODIMENTS

The disclosure provides a data diode in which the occurrence of overflow can be prevented while security is ensured.

Embodiments will be described in detail below with reference to the drawings.

### Embodiment 1

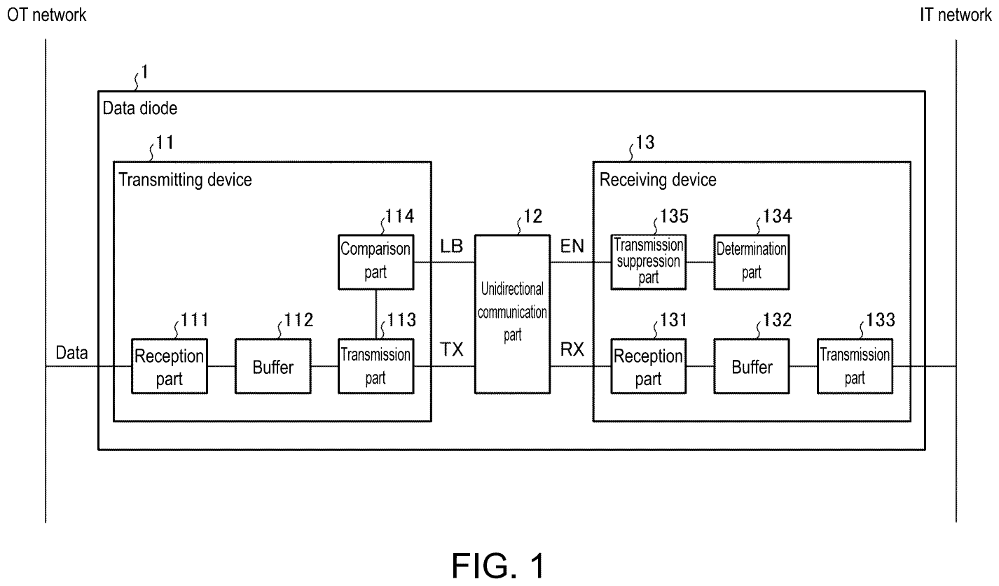

FIG. 1 illustrates a configuration example of a data diode 1 according to Embodiment 1. The data diode 1 is a device that performs unidirectional communication from an OT network (control network) to an IT network (business network) using electrical signals or optical signals.

In the data diode 1 according to Embodiment 1, an aim is to achieve a necessary function without creating an information transmission path in the reverse direction. Here, the necessary function refers to a function of, by appropriately controlling communication according to differences or changes in communication capacity of each communication path, efficiently using the capacity of the communication path while preventing data loss. That is, the aim is to realize this function, which is common in normal communication, even in the data diode 1 where information transmission in the reverse direction is not possible.

As illustrated in FIG. 1, the data diode 1 includes, for example, a transmitting device 11, a unidirectional communication part 12, and a receiving device 13.

The transmitting device 11 transmits data from the OT network to the unidirectional communication part 12.

As illustrated in FIG. 1, the transmitting device 11 includes, for example, a reception part 111, a buffer 112, a transmission part 113, and a comparison part 114.

The reception part 111 receives data from the OT network.

The buffer 112 temporarily accumulates data received by the reception part 111.

The transmission part 113 transmits data accumulated in the buffer 112 to the unidirectional communication part 12. In FIG. 1, the data transmitted from the transmission part 113 to the unidirectional communication part 12 is indicated as TX.

In the case where it is determined by the comparison part 114 that the data do not match (the word “match” includes the meaning of “substantially match”), the transmission part 113 stops transmitting the data accumulated in the buffer 112 to the unidirectional communication part 12.

The comparison part 114 compares the data transmitted to the unidirectional communication part 12 by the transmission part 113 with data returned from the unidirectional communication part 12. In FIG. 1, the data returned from the unidirectional communication part 12 is indicated as LB.

The unidirectional communication part 12 transmits the data from the transmitting

device 11 to the receiving device 13. The unidirectional communication part 12 also returns the data transmitted from the transmitting device 11 to the receiving device 13 back to the transmitting device 11. In FIG. 1, the data transmitted from the unidirectional communication part 12 to the receiving device 13 is indicated as RX.

If a transmission suppression signal is input from the receiving device 13, the unidirectional communication part 12 stops transmitting data from the transmitting device 11 to both the receiving device 13 and the transmitting device 11. In FIG. 1, the transmission suppression signal transmitted from the receiving device 13 to the unidirectional communication part 12 is indicated as EN.

A configuration example of the unidirectional communication part 12 will be described later.

The receiving device 13 transmits the data from the transmitting device 11 via the unidirectional communication part 12 to the IT network.

As illustrated in FIG. 1, the receiving device 13 includes, for example, a reception part 131, a buffer 132, a transmission part 133, a determination part 134, and a transmission suppression part 135.

The reception part 131 receives the data from the transmitting device 11 via the unidirectional communication part 12.

The buffer 132 temporarily accumulates the data received by the reception part 131.

The transmission part 133 transmits the data accumulated by the buffer 132 to the IT network.

The determination part 134 determines the necessity of suppressing data transmission from the transmitting device 11 via the unidirectional communication part 12. That is, for example, the determination part 134 continuously or regularly confirms free space in the buffer 132, and, if the free space reaches a predetermined capacity or less, determines that suppression of data transmission is necessary.

In the receiving device 13, in the case where data is transmitted by the transmission part 133, it is not possible to immediately make free an area corresponding to the amount of data in the buffer 132, and a free area can be provided when a response is obtained indicating that the data has been received by the IT network side being the destination. On the other hand, if a response is obtained indicating that the data could not be received by the IT network side being the destination, it is necessary to retransmit the data. Such an operation is also subject to determination by the determination part 134.

The determination part 134 is realized by a processing circuit such as a system large scale integration (LSI), or a central processing unit (CPU) that executes a program stored in a memory or the like.

If it is determined by the determination part 134 that suppression of data transmission is necessary, the transmission suppression part 135 outputs the transmission suppression signal to the unidirectional communication part 12. The transmission suppression signal is a signal for requesting suppression of data transmission.

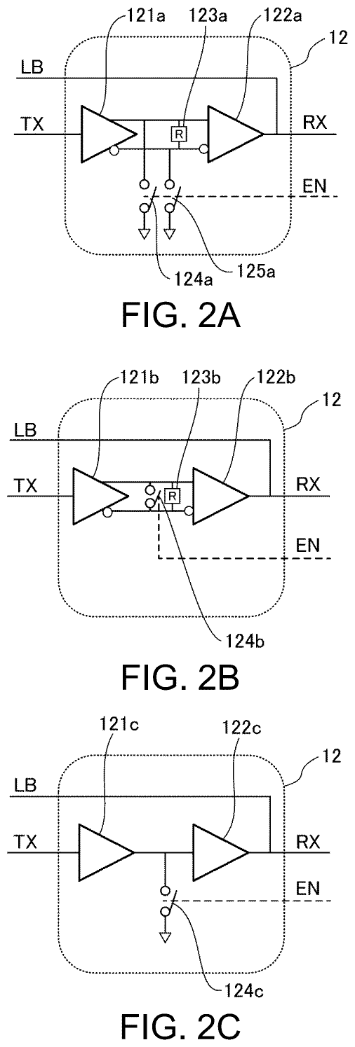

Next, configuration examples of the unidirectional communication part 12 will be described with reference to FIG. 2A to FIG. 4B.

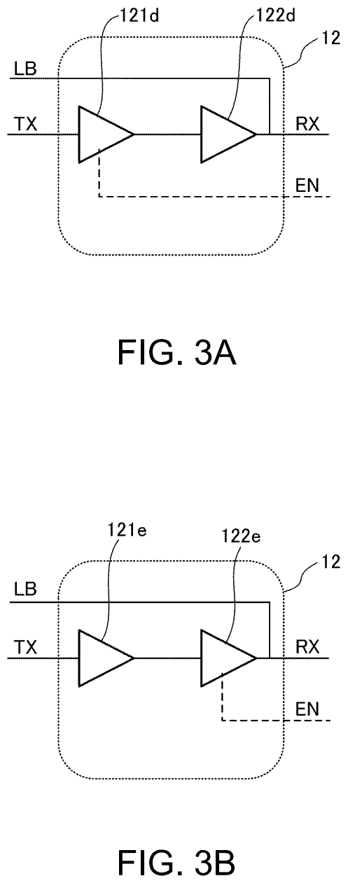

First, configuration examples of the unidirectional communication part 12 in the case where the data diode 1 uses electrical signals will be described with reference to FIG. 2A to FIG. 2C and FIG. 3A to FIG. 3B.

For example, FIG. 2A illustrates a configuration example of the case of stopping transmission by grounding two signal lines for performing differential transmission that are included in the unidirectional communication part 12. In this case, as illustrated in FIG. 2A for example, the unidirectional communication part 12 includes a driver 121a, a receiver 122a, a resistor 123a, a switch 124a, and a switch 125a.

The driver 121a has its input terminal connected to an output terminal (transmission part 113) of the transmitting device 11, its first output terminal connected to a first input terminal of the receiver 122a via one signal line, and its second output terminal connected to a second input terminal of the receiver 122a via the other signal line.

The receiver 122a has its first input terminal connected to a first output terminal of the driver 121a via one signal line, its second input terminal connected to a second output terminal of the driver 121a via the other signal line, and its output terminal connected to an input terminal (reception part 131) of the receiving device 13 and an input terminal (comparison part 114) of the transmitting device 11.

The resistor 123a has one end connected to the first output terminal of the driver 121a and the first input terminal (that is, one signal line) of the receiver 122a, and the other end connected to the second output terminal of the driver 121a and the second input terminal (that is, the other signal line) of the receiver 122a.

The switch 124a has one end connected to the first output terminal of the driver 121a and the first input terminal (that is, one signal line) of the receiver 122a, and the other end grounded.

The switch 124a disconnects the lines in response to the transmission suppression signal being input from the receiving device 13.

The switch 125a has one end connected to the second output terminal of the driver 121a and the second input terminal (that is, the other signal line) of the receiver 122a, and the other end grounded.

The switch 125a disconnects the lines in response to the transmission suppression signal being input from the receiving device 13.

For example, FIG. 2B illustrates a configuration example of the case of stopping transmission by short-circuiting two signal lines for performing differential transmission that are included in the unidirectional communication part 12. In this case, as illustrated in FIG. 2B for example, the unidirectional communication part 12 includes a driver 121b, a receiver 122b, a resistor 123b, and a switch 124b.

The driver 121b has its input terminal connected to the output terminal (transmission part 113) of the transmitting device 11, its first output terminal connected to a first input terminal of the receiver 122b via one signal line, and its second output terminal connected to the second input terminal of the receiver 122b via the other signal line.

The receiver 122b has its first input terminal connected to a first output terminal of the driver 121b via one signal line, its second input terminal connected to a second output terminal of the driver 121b via the other signal line, and its output terminal connected to the input terminal (reception part 131) of the receiving device 13 and the input terminal (comparison part 114) of the transmitting device 11.

The resistor 123b has one end connected to the first output terminal of the driver 121b and the first input terminal (that is, one signal line) of the receiver 122b, and the other end connected to the second output terminal of the driver 121b and the second input terminal (that is, the other signal line) of the receiver 122b.

The switch 124b has one end connected to the first output terminal of the driver 121b and the first input terminal (that is, one signal line) of the receiver 122b, and the other end connected to the second output terminal of the driver 121b and the second input terminal (that is, the other signal line) of the receiver 122b.

The switch 124b connects the lines in response to the transmission suppression signal being input from the receiving device 13.

For example, FIG. 2C illustrates a configuration example of the case of stopping transmission by grounding one single signal line for performing single-ended transmission that is included in the unidirectional communication part 12. In this case, as illustrated in FIG. 2C for example, the unidirectional communication part 12 includes a driver 121c, a receiver 122c, and a switch 124c.

The driver 121c has its input terminal connected to the output terminal (transmission part 113) of the transmitting device 11, and its output terminal connected to an input terminal of the receiver 122c via the signal line.

The receiver 122c has its input terminal connected to the output terminal of the driver 121c via the signal line, and its output terminal connected to the input terminal (reception part 131) of the receiving device 13 and the input terminal (comparison part 114) of the transmitting device 11.

The switch 124c has one end connected to the output terminal of the driver 121c and the input terminal (that is, the signal line) of the receiver 122c, and the other end grounded.

The switch 124c connects the lines in response to the transmission suppression signal being input from the receiving device 13.

For example, FIG. 3A illustrates a configuration example of the case where the unidirectional communication part 12 stops transmission using an enable terminal in a driver 121d. This method can be implemented for both single-ended transmission and differential transmission. FIG. 3A illustrates a case of a single-ended configuration. In this case, as illustrated in FIG. 3A for example, the unidirectional communication part 12 includes the driver 121d and a receiver 122d.

The driver 121d has its input terminal connected to the output terminal (transmission part 113) of the transmitting device 11, and its output terminal connected to an input terminal of the receiver 122d via a signal line.

The driver 121d stops signal output in response to the transmission suppression signal being input from the receiving device 13 to the enable terminal.

The receiver 122d has its input terminal connected to the output terminal of the driver 121d via a signal line, and its output terminal connected to the input terminal (reception part 131) of the receiving device 13 and the input terminal (comparison part 114) of the transmitting device 11.

For example, FIG. 3B illustrates a configuration example of the case where the unidirectional communication part 12 stops transmission using an enable terminal in a receiver 122e. This method can be implemented for both single-ended transmission and differential transmission. FIG. 3B illustrates a case of a single-ended configuration. In this case, as illustrated in FIG. 3B for example, the unidirectional communication part 12 includes a driver 121e and the receiver 122e.

The driver 121e has its input terminal connected to the output terminal (transmission part 113) of the transmitting device 11, and its output terminal connected to an input terminal of the receiver 122e via a signal line.

The receiver 122e has its input terminal connected to the output terminal of the driver 121e via a signal line, and its output terminal connected to the input terminal (reception part 131) of the receiving device 13 and the input terminal (comparison part 114) of the transmitting device 11.

The receiver 122e stops signal output in response to the transmission suppression signal being input from the receiving device 13 to the enable terminal.

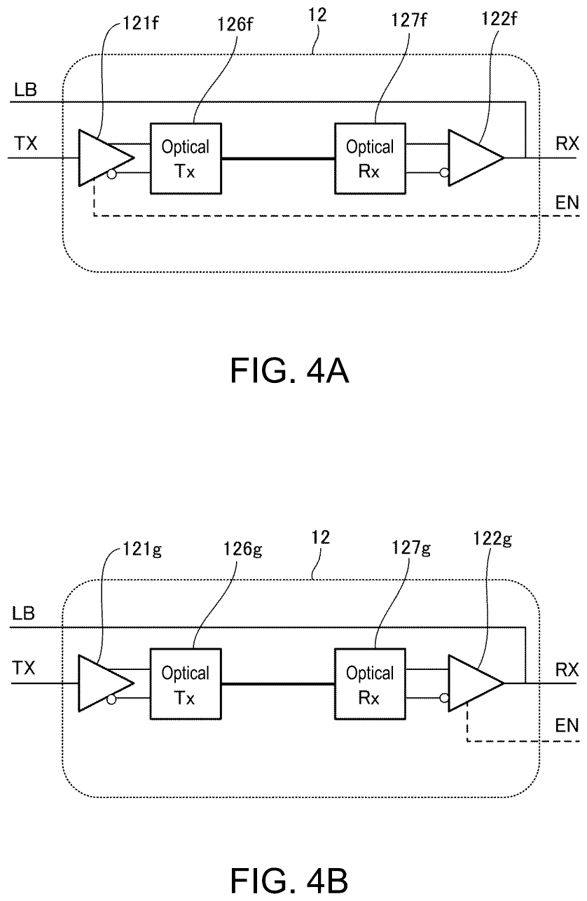

Next, a configuration example of the unidirectional communication part 12 in the case where the data diode 1 uses optical signals (in the case of optical communication) will be described with reference to FIG. 4A and FIG. 4B.

For example, FIG. 4A illustrates a configuration example of the case where the unidirectional communication part 12 stops transmission using an enable terminal in a driver 121f. In this case, as illustrated in FIG. 4A for example, the unidirectional communication part 12 includes the driver 121f, an optical transceiver (optical Tx) 126f, an optical transceiver (optical Rx) 127f, and a receiver 122f.

The driver 121f has its input terminal connected to the output terminal (transmission part 113) of the transmitting device 11, its first output terminal connected to a first input terminal of the optical transceiver 126f, and its second output terminal connected to the second input terminal of the optical transceiver 126f.

The driver 121f stops signal output in response to the transmission suppression signal being input from the receiving device 13 to the enable terminal.

The optical transceiver 126f converts an input signal from an electrical signal to an optical signal. The optical transceiver 126f has its first input terminal connected to the first output terminal of the driver 121f, its second input terminal connected to the second output terminal of the driver 121f, and its output terminal connected to an input terminal of the optical transceiver 127f via an optical fiber.

The optical transceiver 127f converts an input signal from an optical signal to an electrical signal. The optical transceiver 127f has its input terminal connected to the output terminal of the optical transceiver 126f via an optical fiber, its first output terminal connected to a first input terminal of the receiver 122f, and its second output terminal connected to a second input terminal of the receiver 122f.

The receiver 122f has its first input terminal connected to the first output terminal of the optical transceiver 127f, its second input terminal connected to the second output terminal of the optical transceiver 127f, and its output terminal connected to the input terminal (reception part 131) of the receiving device 13 and the input terminal (comparison part 114) of the transmitting device 11.

For example, FIG. 4B illustrates a configuration example of the case where the unidirectional communication part 12 stops transmission using an enable terminal in a receiver 122g. In this case, as illustrated in FIG. 4B for example, the unidirectional communication part 12 includes a driver 121g, an optical transceiver (optical Tx) 126g, an optical transceiver (optical Rx) 127g, and the receiver 122g.

The driver 121g has its input terminal connected to the output terminal (transmission part 113) of the transmitting device 11, its first output terminal connected to a first input terminal of the optical transceiver 126g, and its second output terminal connected to a second input terminal of the optical transceiver 126g.

The optical transceiver 126g converts an input signal from an electrical signal to an optical signal. The optical transceiver 126g has its first input terminal connected to the first output terminal of the driver 121g, its second input terminal connected to the second output terminal of the driver 121g, and its output terminal connected to an input terminal of the optical transceiver 127g via an optical fiber.

The optical transceiver 127g converts an input signal from an optical signal to an electrical signal. The optical transceiver 127g has its input terminal connected to the output terminal of the optical transceiver 126g via an optical fiber, its first output terminal connected to a first input terminal of the receiver 122g, and its second output terminal connected to a second input terminal of the receiver 122g.

The receiver 122g has its first input terminal connected to the first output terminal of the optical transceiver 127g, its second input terminal connected to the second output terminal of the optical transceiver 127g, and its output terminal connected to the input terminal (reception part 131) of the receiving device 13 and the input terminal (comparison part 114) of the transmitting device 11.

The receiver 122g stops signal output in response to the transmission suppression signal being input from the receiving device 13 to the enable terminal.

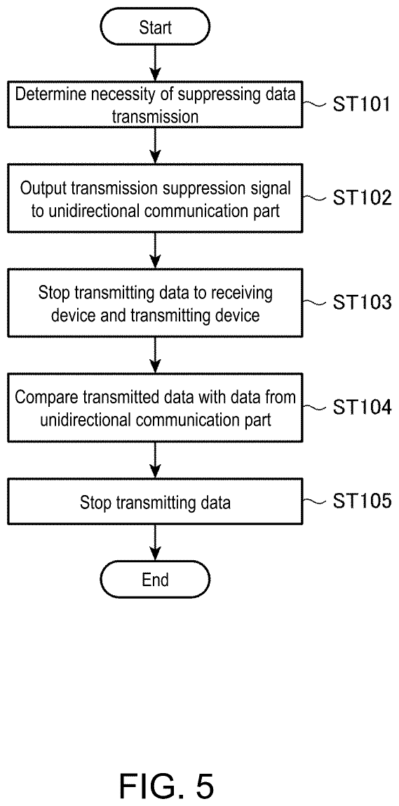

Next, a transmission control operation example of the data diode 1 according to Embodiment 1 illustrated in FIG. 1 will be described with reference to FIG. 5.

In the data diode 1 according to Embodiment 1, the transmitting device 11 transmits data from the OT network to the unidirectional communication part 12, the unidirectional communication part 12 transmits data from the transmitting device 11 to the receiving device 13, and the receiving device 13 transmits data from the transmitting device 11 via the unidirectional communication part 12 to the IT network. The unidirectional communication part 12 also returns the data transmitted from the transmitting device 11 to the receiving device 13 back to the transmitting device 11.

In the transmission control operation example of the data diode 1 according to Embodiment 1 illustrated in FIG. 1, first, as illustrated in FIG. 5 for example, the determination part 134 in the receiving device 13 determines the necessity of suppressing data transmission from the transmitting device 11 via the unidirectional communication part 12 (step ST101). That is, the determination part 134 continuously or regularly confirms free space in the buffer 132, and, if the free space reaches a predetermined capacity or less, determines that suppression of data transmission is necessary.

Next, if it is determined by the determination part 134 that suppression of data transmission is necessary, the transmission suppression part 135 in the receiving device 13 outputs the transmission suppression signal to the unidirectional communication part 12 (step ST102).

Next, if the transmission suppression signal is input from the receiving device 13, the unidirectional communication part 12 stops transmitting data from the transmitting device 11 to both the receiving device 13 and the transmitting device 11 (step ST103).

Next, the comparison part 114 in the transmitting device 11 compares the data transmitted to the unidirectional communication part 12 by the transmission part 113 with the data returned from the unidirectional communication part 12 (step ST104).

Next, if it is determined by the comparison part 114 that the data do not match, the transmission part 113 stops transmitting the data accumulated in the buffer 112 to the unidirectional communication part 12 (step ST105).

As described above, in the data diode 1 according to Embodiment 1, data (signals) from the transmitting device 11 are transmitted to the driver 121, and the data (signals) received by the receiver 122 are communicated to the receiving device 13 as well as looped back to the transmitting device 11. The transmitting device 11 then compares the data transmitted by itself with the looped-back data. Here, if both sets of data being compared match, the transmitting device 11 can determine that the communication path is not blocked by the receiving device 13.

On the other hand, if the transmission suppression signal is transmitted from the receiving device 13 to the unidirectional communication part 12, the unidirectional communication part 12 stops transmitting the data from the transmitting device 11 to both the receiving device 13 and the transmitting device 11. Accordingly, in the transmitting device 11, both sets of data being compared do not match, and the transmitting device 11 can determine that the communication path is blocked by the receiving device 13. In this way, the transmitting device 11 can be informed that the receiving device 13 is in a state of being unable to receive data for some reason, and may respond by stopping transmission and, for example, perform retransmission after a while.

In this manner, in the data diode 1 according to Embodiment 1, in the case where the receiving device 13 desires to stop data transmission from the transmitting device 11, the receiving device 13 intentionally causes a communication error by blocking communication in the unidirectional communication part 12. Then, the transmitting device 11 is able to determine that a communication error has occurred by comparing the transmitted data with the looped-back data, and is able to stop transmission.

At this time, to transmit information to the transmitting device 11, the receiving device 13 does not directly communicate a signal to the transmitting device 11, but transmits the information by blocking a unidirectional communication path. Hence, even if this blocking signal were to be maliciously hijacked, it is evident that it is only possible to block communication, and it is not possible to enter the OT network.

It is evident that the transmitting device 11 merely loops back a signal being transmitted through the unidirectional communication path, and this cannot be controlled from the receiving device 13.

From the above, the data diode 1 according to Embodiment 1 is able to control transmission and reception while maintaining the nature of the data diode 1.

In the data diode 1, optical communication may be used to realize unidirectional communication. This is because in the case of optical communication, a transmitting side includes a light-emitting element, a receiving side includes a light-receiving element, and an optical communication path is provided therebetween, making it visually apparent that the communication is unidirectional. A characteristic of optical communication is that high-speed and highly reliable communication can be achieved.

In the data diode 1, it is also possible to use an electrical component to realize unidirectional communication. With the electrical component, it is easy to block the communication, thus making it possible to control communication by utilizing this blocking function.

In optical communication, an optical transceiver connected to an optical fiber includes a built-in light-emitting element or light-receiving element. To drive the optical transceiver, a differential signal being a high-speed electrical signal is often used. Hence, even in the case of unidirectional communication using optical communication, the blocking function can be implemented by an electrical signal portion.

Specifically, for example, in the case of a differential communication path, blocking can be achieved by grounding each differential communication path with an analog switch, by short-circuiting both differential signals, or the like.

For example, in the case of a normal single-ended communication path that is not differential, blocking can be achieved by grounding the signal with an analog switch.

For example, for both differential or single-ended, if enable input is provided for a driver or receiver being used, blocking can be achieved by utilizing this input.

As described above, according to Embodiment 1, the data diode 1 includes: the transmitting device 11, transmitting data from the OT network; the receiving device 13, transmitting input data to the IT network; and the unidirectional communication part 12, transmitting data transmitted by the transmitting device 11 to the receiving device 13 and the transmitting device 11. The receiving device 13 includes: the determination part 134, determining the necessity of suppressing data transmission from the transmitting device 11 via the unidirectional communication part 12; and the transmission suppression part 135, in response to the determination part 134 determining that suppression of data transmission is necessary, outputting the transmission suppression signal to the unidirectional communication part 12. The unidirectional communication part 12, in response to receiving the transmission suppression signal from the transmission suppression part 135, stops transmitting data transmitted by the transmitting device 11 to the receiving device 13 and the transmitting device 11. The transmitting device 11 includes the comparison part 114 that compares transmitted data with data from the unidirectional communication part 12, and stops data transmission in response to the comparison part 114 determining that data do not match.

Accordingly, in the data diode 1 according to Embodiment 1, the occurrence of overflow can be prevented while security is ensured.

According to Embodiment 1, the unidirectional communication part 12 includes two signal lines for performing differential transmission, and stops transmitting data transmitted by the transmitting device 11 to the receiving device 13 and the transmitting device 11 by grounding the two signal lines.

According to Embodiment 1, the unidirectional communication part 12 includes two signal lines for performing differential transmission, and stops transmitting data transmitted by the transmitting device 11 to the receiving device 13 and the transmitting device 11 by short-circuiting the two signal lines.

According to Embodiment 1, the unidirectional communication part 12 includes one single signal line for performing single-ended transmission, and stops transmitting data transmitted by the transmitting device 11 to the receiving device 13 and the transmitting device 11 by grounding this signal line.

According to Embodiment 1, the unidirectional communication part 12 includes the driver 121 and the receiver 122 that perform single-ended transmission or differential transmission, and stops transmitting data transmitted by the transmitting device 11 to the receiving device 13 and the transmitting device 11 in response to the transmission suppression signal being input to the enable terminal in the driver 121.

According to Embodiment 1, the unidirectional communication part 12 includes the driver 121 and the receiver 122 that perform single-ended transmission or differential transmission, and stops transmitting data transmitted by the transmitting device 11 to the receiving device 13 and the transmitting device 11 in response to the transmission suppression signal being input to the enable terminal in the receiver 122.

Accordingly, in the data diode 1 according to Embodiment 1, the occurrence of overflow can be prevented while security is ensured.

According to Embodiment 1, the transmission control method is a transmission control method in the data diode 1, the data diode 1 including the transmitting device 11 that transmits data from the OT network, the receiving device 13 that transmits input data to the IT network, and the unidirectional communication part 12 that transmits data transmitted by the transmitting device 11 to the receiving device 13 and the transmitting device 11. The receiving device 13 includes the determination part 134 that determines the necessity of suppressing data transmission from the transmitting device 11 via the unidirectional communication part 12, and the transmission suppression part 135 that outputs the transmission suppression signal to the unidirectional communication part 12 in the case where it is determined by the determination part 134 that suppression of data transmission is necessary. The unidirectional communication part 12 stops transmitting data transmitted by the transmitting device 11 to the receiving device 13 and the transmitting device 11 in response to the transmission suppression signal being input from the transmission suppression part 135. The transmitting device 11 includes the comparison part 114 that compares transmitted data with data from the unidirectional communication part 12, and stops data transmission in the case where it is determined by the comparison part 114 that data do not match.

Accordingly, in the transmission control method according to Embodiment 1, the occurrence of overflow can be prevented while security is ensured.

### Embodiment 2

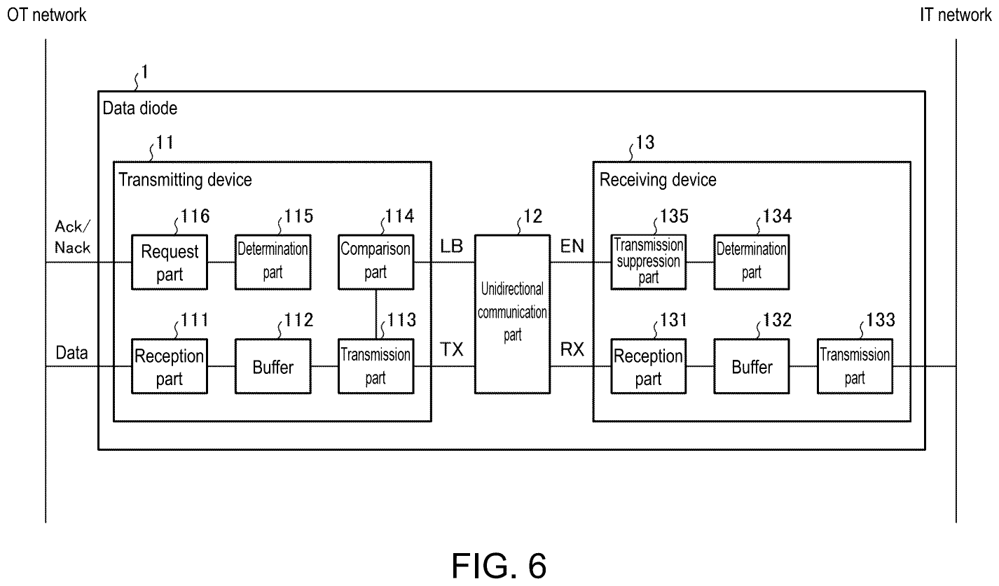

FIG. 6 illustrates a configuration example of the data diode 1 according to Embodiment 2. In the data diode 1 according to Embodiment 2 illustrated in FIG. 6, compared to the data diode 1 according to Embodiment 1 illustrated in FIG. 1, a determination part (second determination part) 115 and a request part 116 are added to the transmitting device 11. Other configuration examples in the data diode 1 according to Embodiment 2 illustrated in FIG. 6 are similar to the configuration examples in the data diode 1 according to Embodiment 1 and are assigned the same reference numerals. Only the different portions will be described.

The determination part 115 determines the necessity of temporary stop of transmission of or retransmission of data from the OT network. That is, for example, the determination part 115 continuously or regularly confirms free space in the buffer 112, and, if the free space reaches a predetermined capacity or less, determines that temporary stop of transmission of or retransmission of data is necessary.

The request part 116, in the case where it is determined by the determination part 115 that temporary stop of transmission of or retransmission of data is necessary, outputs a request signal to the OT network (source of data). The request signal is a signal for requesting temporary stop of transmission of or retransmission of data, such as Nack.

Then, the OT network side, in response to the request signal being input from the transmitting device 11, performs temporary stop of transmission of or retransmission of data to the transmitting device 11.

For example, in the case of a Transmission Control Protocol (TCP) communication protocol, temporary stop of transmission of data can be achieved by the transmitting device 11 rejecting a connection request from the OT network side, and retransmission of data can be achieved by the transmitting device 11 responding that data from the OT network side has not been received.

That is, in the TCP, data transfer is started after a connection is established.

At this time, a signal indicating a connection establishment request is transmitted from the source. If there is little free space in the buffer 112, the transmitting device 11 transmits to the source the request signal that rejects the connection establishment request. When the transmitting device 11 rejects the connection establishment request, the source becomes unable to transmit data, and temporary stop of transmission of data is thereby achieved.

In the case where a connection has been established and data transfer has begun, if the data is large, the source divides that data into multiple packets for transmission. Then, if the free space in the buffer 112 is decreased during reception of these multiple packets, the transmitting device 11 is unable to store all the packets in the buffer 112. Hence, the transmitting device 11 transmits to the source a sequence number (number indicating how much data can be received) of the packets that can stored in the buffer 112 as the request signal. Accordingly, the source is able to retransmit the packets that could not be stored in the buffer 112.

As described above, according to Embodiment 2, the transmitting device 11 includes: the determination part 115, determining the necessity of temporary stop of transmission of or retransmission of data from the OT network; and the request part 116, in response to the determination part 115 determining that temporary stop of transmission of or retransmission of data is necessary, outputting the request signal to the OT network.

Accordingly, in addition to the effects of Embodiment 1, the data diode 1 according to Embodiment 2 is able to cope with the case where there is little free space in the buffer 112 on the transmitting device 11 side.

It should be noted that free combinations of each embodiment, or modifications of any component in each embodiment, or omission of any component in each embodiment are possible.

What is claimed is:

1. A data diode comprising:
a transmitting device, transmitting data from a control network;
a receiving device, transmitting input data to a business network; and
a unidirectional communication part, transmitting data transmitted by the transmitting device to the receiving device and the transmitting device, wherein
the receiving device comprises:
a determination part, determining necessity of suppressing data transmission from the transmitting device via the unidirectional communication part; and
a transmission suppression part, in response to the determination part determining that suppression of data transmission is necessary, outputting a transmission suppression signal to the unidirectional communication part;
the unidirectional communication part, in response to receiving the transmission suppression signal from the transmission suppression part, stops transmitting data transmitted by the transmitting device to the receiving device and the transmitting device;
the transmitting device comprises a comparison part that compares transmitted data with data from the unidirectional communication part, and
the transmitting device stops data transmission in response to the comparison part determining that data do not match.

2. The data diode according to claim 1, wherein
the unidirectional communication part comprises two signal lines for performing differential transmission, and stops transmitting data transmitted by the transmitting device to the receiving device and the transmitting device by grounding the two signal lines.

3. The data diode according to claim 1, wherein
the unidirectional communication part comprises two signal lines for performing differential transmission, and stops transmitting data transmitted by the transmitting device to the receiving device and the transmitting device by short-circuiting the two signal lines.

4. The data diode according to claim 1, wherein
the unidirectional communication part comprises one single signal line for performing single-ended transmission, and stops transmitting data transmitted by the transmitting device to the receiving device and the transmitting device by grounding the one single signal line.

5. The data diode according to claim 1, wherein
the unidirectional communication part comprises a driver and a receiver that perform single-ended transmission or differential transmission, and stops transmitting data transmitted by the transmitting device to the receiving device and the transmitting device by a transmission suppression signal being input to an enable terminal in the driver.

6. The data diode according to claim 1, wherein
the unidirectional communication part comprises a driver and a receiver that perform single-ended transmission or differential transmission, and stops transmitting data transmitted by the transmitting device to the receiving device and the transmitting device by a transmission suppression signal being input to an enable terminal in the receiver.

7. The data diode according to claim 1, wherein
the transmitting device comprises:
a second determination part, determining necessity of temporary stop of transmission of or retransmission of data from the control network; and
a request part, in response to the second determination part determining that temporary stop of transmission of or retransmission of data is necessary, outputting a request signal to the control network.

8. A transmission control method in a data diode, the data diode comprising a transmitting device that transmits data from a control network, a receiving device that transmits input data to a business network, and a unidirectional communication part that transmits data transmitted by the transmitting device to the receiving device and the transmitting device, wherein the transmission control method comprises:
in the receiving device,
by a determination part, determining necessity of suppressing data transmission from the transmitting device via the unidirectional communication part; and
by a transmission suppression part, outputting a transmission suppression signal to the unidirectional communication part in response to a determination by the determination part that suppression of data transmission is necessary;
in response to receiving the transmission suppression signal from the transmission suppression part, by the unidirectional communication part, stopping transmitting data transmitted by the transmitting device to the receiving device and the transmitting device;
in the transmitting device,
by a comparison part, comparing transmitted data with data from the unidirectional communication part, and
in response to a determination by the comparison part that data do not match, stopping data transmission.
